(19) United States
(12) Patent Application Publication
(10) Pub. No.: US 2006/0038368 A1
(43) Pub. Date: Feb. 23, 2006

(54) Sunshade device for stroller

(76) Inventor: Stephen Hu, Hsin-Chu Industrial Park (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/919,705

(22) Filed: Aug. 17, 2004

(51) Int. Cl. B62B 3/00

(52) U.S. Cl. 280/47.371

(57) ABSTRACT

A sunshade device for a stroller includes two connecting mechanisms, a first support bracket, and a second support bracket. Each of the two connecting mechanisms includes a support member, a first pivot member, and a second pivot member. Thus, the first pivot member and the second pivot member are spaced from each other and are mounted on different sides of the support member, so that when the sunshade device is folded, the first support bracket is spaced from the second support bracket with a determined distance, thereby preventing a user's finger from being clamped and hurt by the first support bracket and the second support bracket so as to protect the user's safety.

### BACKGROUND OF THE INVENTION

1. Field of the Invention

The present invention relates to a sunshade device, and more particularly to a sunshade device for a stroller.

2. Description of the Related Art

A conventional sunshade device 1 for a stroller in accordance with the prior art shown in FIG. 5 comprises a connecting mechanism 13 mounted on a frame 20 of the stroller, a pivot shaft 14 mounted on the connecting mechanism 13, and two support brackets 11 and 12 each pivotally mounted on the pivot shaft 14. However, the two support brackets 11 and 12 are mounted on the same pivot shaft 14. Thus, when the sunshade device 1 is folded, the two support brackets 11 and 12 abut each other, so that a user's finger is easily clamped and hurt by the two intersecting support brackets 11 and 12, thereby causing danger to the user.

### SUMMARY OF THE INVENTION

In accordance with the present invention, there is provided a sunshade device for a stroller, comprising:

two connecting mechanisms each including a support member, a first pivot member mounted on the support member, and a second pivot member mounted on the support member;

a first support bracket having two ends each pivotally mounted on the first pivot member of a respective one of the two connecting mechanisms; and

a second support bracket having two ends each pivotally mounted on the second pivot member of a respective one of the two connecting mechanisms.

The primary objective of the present invention is to provide a sunshade device that is operated in a safe manner when being folded to prevent from causing danger to a user.

Another objective of the present invention is to provide a sunshade device for a stroller, wherein the first pivot member and the second pivot member are spaced from each other and are mounted on different sides of the support member, so that when the first support bracket is moved toward the second support bracket, the first support bracket is spaced from the second support bracket with a determined distance, thereby preventing a user's finger from being clamped and hurt by the first support bracket and the second support bracket when the sunshade device is folded so as to protect the user's safety.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a stroller in accordance with the preferred embodiment of the present invention;

FIG. 2 is a partially cut-away perspective view of the stroller as shown in FIG. 1;

FIG. 3 is a schematic operational view of the stroller as shown in FIG. 2;

FIG. 4 is a schematic plan operational view of the stroller as shown in FIG. 2; and

FIG. 5 is a plan operational view of a conventional sunshade device for a stroller in accordance with the prior art.

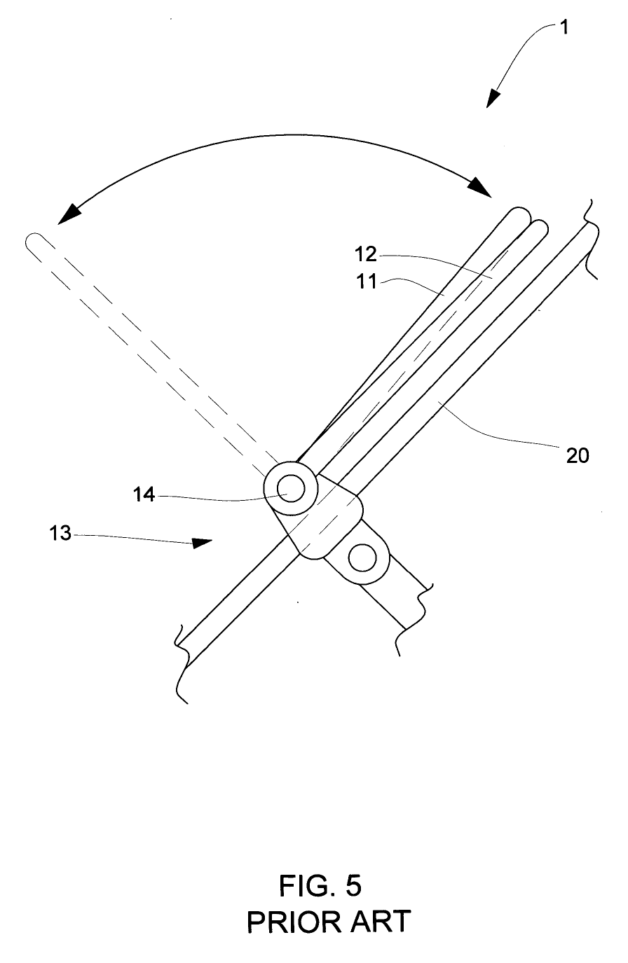

### DETAILED DESCRIPTION OF THE INVENTION

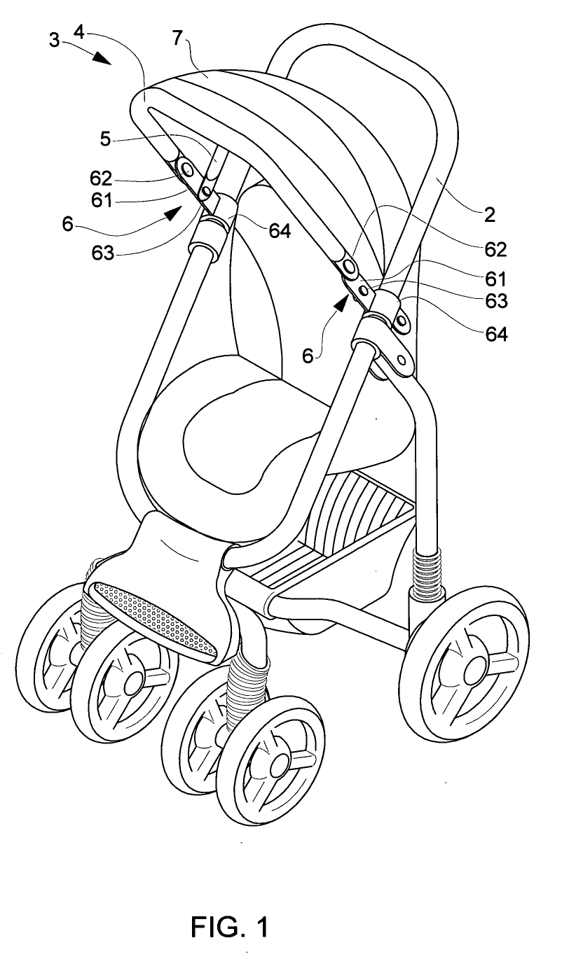

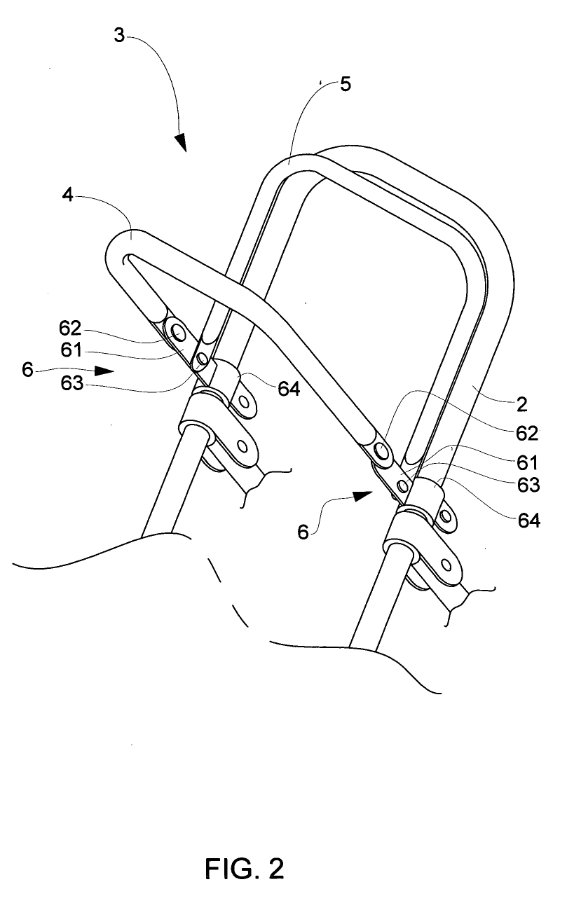

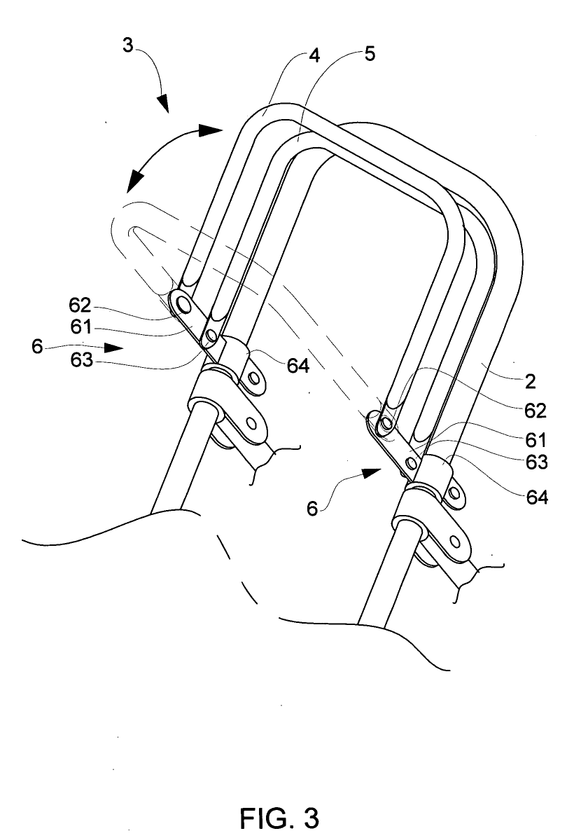

Referring to the drawings and initially to FIGS. 1-3, a stroller in accordance with the preferred embodiment of the present invention comprises a substantially U-shaped frame 2, and a sunshade device 3 mounted on the frame 2.

The sunshade device 3 includes two connecting mechanisms 6 each mounted on the frame 2 and each including a support member 61 attached to the frame 2, a first pivot member 62 mounted on the support member 61, and a second pivot member 63 mounted on the support member 61 and spaced from the first pivot member 62, a substantially U-shaped first support bracket 4 having two ends each pivotally mounted on the first pivot member 62 of a respective one of the two connecting mechanisms 6, and a substantially U-shaped second support bracket 5 having two ends each pivotally mounted on the second pivot member 63 of a respective one of the two connecting mechanisms 6.

The sunshade device 3 further includes a canopy 7 mounted between the first support bracket 4 and the second support bracket 5. The support member 61 has a side formed with a coupling portion 64 secured on the frame 2. Preferably, the first pivot member 62 and the second pivot member 63 are mounted on different sides of the support member 61. Preferably, the first pivot member 62 is mounted on a first side of the support member 61, and the second pivot member 63 is mounted on a second side of the support member 61.

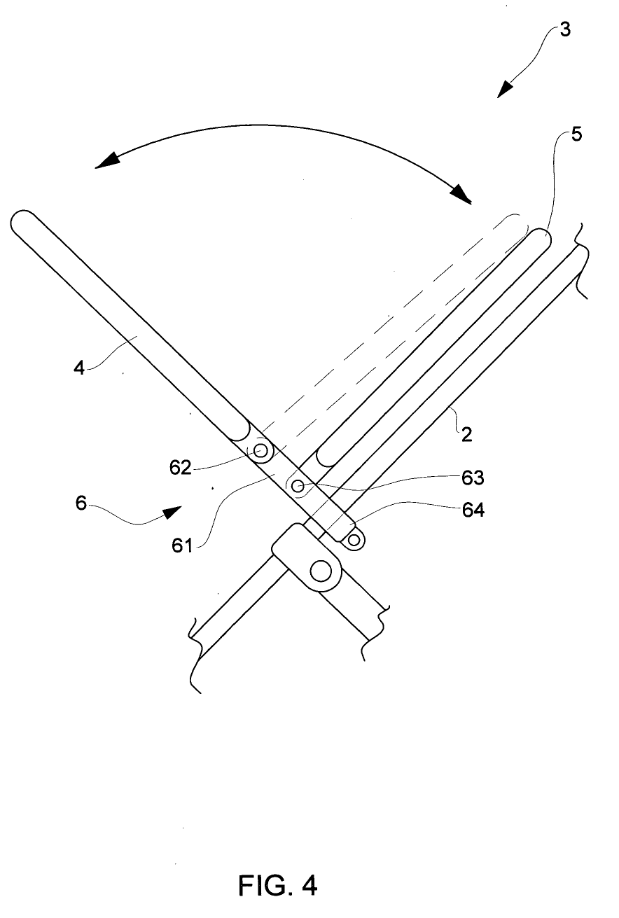

Referring to FIGS. 1-4, the first pivot member 62 and the second pivot member 63 are spaced from each other and are mounted on different sides of the support member 61, so that when the first support bracket 4 is moved toward the second support bracket 5, the first support bracket 4 is spaced from the second support bracket 5 with a determined distance, thereby preventing a user's finger from being clamped and hurt by the first support bracket 4 and the second support bracket 5 when the sunshade device 3 is folded so as to protect the user's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A sunshade device for a stroller, comprising:
two connecting mechanisms each including a support member, a first pivot member mounted on the support member, and a second pivot member mounted on the support member;
a first support bracket having two ends each pivotally mounted on the first pivot member of a respective one of the two connecting mechanisms; and
a second support bracket having two ends each pivotally mounted on the second pivot member of a respective one of the two connecting mechanisms.

2. The sunshade device for a stroller in accordance with claim 1, wherein the first pivot member and the second pivot member are spaced from each other.

3. The sunshade device for a stroller in accordance with claim 1, wherein the first pivot member and the second pivot member are mounted on different sides of the support member.

4. The sunshade device for a stroller in accordance with claim 1, wherein the first pivot member is mounted on a first side of the support member, and the second pivot member is mounted on a second side of the support member.

5. The sunshade device for a stroller in accordance with claim 1, wherein the support member is attached to a frame.

6. The sunshade device for a stroller in accordance with claim 1, wherein the support member has a side formed with a coupling portion secured on a frame.

7. The sunshade device for a stroller in accordance with claim 1, wherein each of the two ends of the first support bracket is spaced from a respective one of the two ends of the second support bracket.
